(19) United States
(12) Patent Application Publication
(10) Pub. No.: US 2024/0323946 A1
(43) Pub. Date: Sep. 26, 2024

(54) ADAPTIVE MULTI-COMPONENT CARRIER SCHEDULING FOR PHYSICAL UPLINK SHARED CHANNEL (PUSCH) TRANSMISSIONS

(71) Applicant: QUALCOMM Incorporated, San Diego, CA (US)

(72) Inventors: Diana Maamari, San Diego, CA (US); Ahmed Elshafie, San Diego, CA (US); Huilin Xu, Temecula, CA (US); Konstantinos Dimou, New York City, NY (US)

(21) Appl. No.: 18/186,803

(22) Filed: Mar. 20, 2023

(51) Int. Cl. H04W 72/12; H04L 5/00; H04W 72/232

(52) U.S. Cl. CPC H04W 72/12; H04L 5/001; H04W 72/232

(57) ABSTRACT

This disclosure provides systems, methods, and devices for wireless communication that support adaptive multi-component carrier scheduling for physical uplink shared channel (PUSCH) transmissions. In some aspects, a method of wireless communication includes a user equipment (UE) receiving from a base station, a downlink control information configured to schedule a PUSCH transmission to the base station using a first number of component carriers. The UE may transmit to the base station a portion of the PUSCH transmission via the first number of component carriers. The UE may then transmit, to the base station, the remaining portion of the PUSCH transmission using a second number of component carriers based on an uplink packet delay budget (PDB) remaining after transmitting the portion of the PUSCH transmission via the first number of component carriers. In some aspects, the second number of component carriers is greater than the first number of component carriers.

### TECHNICAL FIELD

Aspects of the present disclosure relate generally to wireless communication systems, and more particularly, to adaptive multi-component carrier scheduling for physical uplink shared channel (PUSCH) transmissions. Some features may enable and provide improved communications, including improved data transmission reliability, efficient resource utilization, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipment (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

When a UE communicates with a base station, such as when the UE transmits physical uplink shared channel (PUSCH) transmissions to the base station via a component carrier, there may be a time limit associated with the transmissions. For example, when a UE sends a data packet to a base station, there is an associated packet delay budget (PDB) that defines an upper bound for the time that the data packet may be delayed between the UE and the core network/radio access network. If the UE reaches the time limit before the uplink transmission is completed, the remaining UL data may be dropped, or at least may not be transmitted over the scheduled resources, resulting in subpar user experience, inefficient resource use, network unreliability, etc.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication performed by a user equipment (UE) includes receiving, from a base station, a downlink control information (DCI) configured to schedule a physical uplink shared channel (PUSCH) transmission, from the UE to the base station, via a first number of component carriers (CCs). The method further comprises transmitting, to the base station, a portion of the PUSCH transmission via the first number of CCs. The method also comprises transmitting, to the base station, a remaining portion of the PUSCH transmission via a second number of CCs based on an uplink packet delay budget (PDB) remaining after transmitting the PUSCH transmission via the first number of CCs. In some aspects, the second number of CCs is greater than the first number of CCs.

In an additional aspect of the disclosure, a user equipment (UE) includes at least one processor and a memory coupled to the at least one processor. The at least one processor is configured to receive, from a base station, a DCI configured to schedule a PUSCH transmission, from the UE to the base station, via a first number of CCs. The at least one processor is further configured to transmit, to the base station, a portion of the PUSCH transmission via the first number of CCs. Further, the at least one processor is configured to transmit, to the base station, a remaining portion of the PUSCH transmission via a second number of CCs based on an uplink PDB remaining after transmitting the PUSCH transmission via the first number of CCs. In some aspects, the second number of CCs is greater than the first number of CCs.

In an additional aspect of the disclosure, an apparatus includes means for receiving, from a base station, a DCI configured to schedule a PUSCH transmission, from a UE to the base station, via a first number of CCs. The apparatus further includes means for transmitting, to the base station, a portion of the PUSCH transmission via the first number of CCs. Further, the apparatus includes means for transmitting, to the base station, a remaining portion of the PUSCH transmission via a second number of CCs based on an uplink PDB remaining after transmitting the PUSCH transmission via the first number of CCs. In some aspects, the second number of CCs is greater than the first number of CCs.

In an additional aspect of the disclosure, a non-transitory computer-readable medium stores instructions that, when executed by a processor, cause the processor to perform operations. The operations include receiving, from a base station, a DCI configured to schedule a PUSCH transmission, from a UE to the base station, via a first number of CCs. The operations further include transmitting, to the base station, a portion of the PUSCH transmission via the first number of CCs. The operations also comprise transmitting, to the base station, a remaining portion of the PUSCH transmission via a second number of CCs based on an uplink PDB remaining after transmitting the PUSCH transmission using the first number of CCs. In some aspects, the second number of CCs is greater than the first number of CCs.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports adaptive multi-component carrier scheduling for physical uplink shared channel (PUSCH) transmissions according to one or more aspects.

FIG. 4 is a flow diagram illustrating an example process that supports adaptive multi-component carrier scheduling for physical uplink shared channel (PUSCH) transmissions according to one or more aspects.

FIG. 5 is a block diagram of an example UE that supports adaptive multi-component carrier scheduling for physical uplink shared channel (PUSCH) transmissions according to one or more aspects.

FIG. 6 is a block diagram of an example base station that supports adaptive multi-component carrier scheduling for physical uplink shared channel (PUSCH) transmissions according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support adaptive multi-component carrier scheduling for physical uplink shared channel (PUSCH) transmissions. In some aspects, a user equipment (UE) may be explicitly or implicitly adapted or configured to utilize multiple component carriers for transmitting PUSCH transmissions. In the explicit case, the UE may receive from the base station a single downlink control information (DCI) that is configured to schedule multiple component carriers for the PUSCH transmissions. For example, the DCI may include multiple carrier indicator fields (CIFs), where each CIF indicates the component carrier(s) that the UE can utilize for the PUSCH transmissions. That is, there may be multiple CIFs in the same DCI, and each CIF may indicate one or more component carriers that can be used by the UE for the PUSCH transmissions. For instance, a DCI may include two CIFs, where the first CIF identifies one component carrier and the second CIF identifies more than one (e.g., two, three, etc.) component carriers. The UE may then select the one component carrier identified by the first CIF or the multiple component carriers identified by the second CIF for the PUSCH transmissions.

The selection can be based on uplink latency or an uplink packet delay budget (PDB) remaining after transmitting a portion of the PUSCH transmissions (e.g., an amount of PDB that is remaining after a portion of the PUSCH is transmitted to a base station via the one component carrier of the first CIF). In some aspects, a PDB may refer to an upper bound for the time that a data packet may be delayed between the UE and the core network/radio access network. For example, the UE may initially commence transmitting the PUSCH via the one component carrier identified by the first CIF. The UE may experience a delay in transmitting the full PUSCH via the one component carrier, and in such cases, the UE may switch to using the multiple component carriers identified by the second CIF for transmitting the remaining PUSCH (e.g., the portion of the PUSCH remaining after the incomplete or partial transmission of the PUSCH via the one component carrier) based on a PDB remaining after the partial transmission of the PUSCH via the one component carrier. For instance, the UE may switch to using the multiple component carriers (e.g., transmit the remaining PUSCH via the multiple component carriers) when the remaining uplink PDB (e.g., the amount of PDB remaining after PUSCH transmission via the one component carrier) fails to satisfy a remaining uplink PDB threshold.

In the implicit case, the UE may be pre-configured by the base station to adaptively switch to using multiple component carriers for the PUSCH transmissions. In some aspects, the UE may receive a radio resource control (RRC) configured value from the base station that indicates the multiple component carriers that the UE may utilize for PUSCH transmissions based on a remaining uplink PDB (e.g., an amount of PDB that is remaining after a portion of the PUSCH transmission is initially transmitted via the one component carrier identified in the DCI, for instance by the first CIF). When transmitting PUSCH to the base station, the UE may then determine whether to switch to using the multiple component carriers identified by the RRC configured value based on the remaining uplink PDB. For example, the UE may receive from the base station a RRC message that includes the RRC configured value, wherein the RRC configured value indicates two or more component carriers for using when the remaining uplink PDB fails to satisfy the remaining uplink PDB threshold. In some aspects, the RRC message and/or RRC configured value may also indicate the remaining uplink PDB threshold. The UE may then receive from the base station a DCI that is configured to schedule a component carrier (e.g., a single component carrier) for the PUSCH transmissions. The UE may initially commence transmitting the PUSCH via the one component carrier identified in the DCI and then switch to using the multiple component carriers identified by the RRC configured value based on the remaining uplink PDB (e.g., the uplink PDB remaining after the partial transmission of the PUSCH via the one component carrier identified in the DCI). For example, the UE may switch to using the multiple component carriers identified by the RRC configured value when the remaining uplink PDB of using the one component carrier fails to satisfy the remaining uplink PDB threshold.

In some aspects, a reference to using a component carrier for transmitting a PUSCH may be understood to refer to the use of a resource allocated for the PUSCH transmission and located within a bandwidth part (BWP) of that component carrier. The resource can be in the frequency domain and may be scheduled by a DCI via its frequency domain resource assignment (FDRA) field. The resource can also be in the time domain and may be scheduled by a DCI via its time domain resource assignment (TDRA) field.

In some aspects, the remaining uplink PDB and/or the remaining uplink PDB threshold may be provided or indicated by the base station to the UE via a physical layer (layer 1) signaling, such as a DCI as discussed above. In some aspects, the base station may utilize a higher layer signaling to provide or indicate to the UE the remaining uplink PDB and/or the remaining uplink PDB threshold. For example, the base station may utilize a layer 2 (L2) message and/or a layer 3 (L3) message to transmit the remaining uplink PDB and/or the remaining uplink PDB threshold to the UE. For instance, the L2/L3 message including or indicating the remaining uplink PDB and/or the remaining uplink PDB threshold can be an RRC message, a medium access control-control element (MAC-CE) message, etc.

Particular implementations of the subject matter described in this disclosure may be implemented to realize one or more of the following potential advantages or benefits. In some aspects, the present disclosure provides techniques for adaptively switching to using multiple component carriers for PUSCH transmissions. Uplink transmissions such as PUSCH transmissions from a UE to a base station may have associated therewith a time limit for completing the transmission. For instance, when a UE sends a data packet to a base station, there is an associated PDB that defines an upper bound for the time that the data packet may be delayed between the UE and the core network/radio access network. The disclosed techniques are directed to mitigating or avoiding the waste in network resources, disruption to network operations, degraded user experiences, etc., that may result when an uplink transmission is delayed, and in some cases, dropped as a consequence.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/see), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

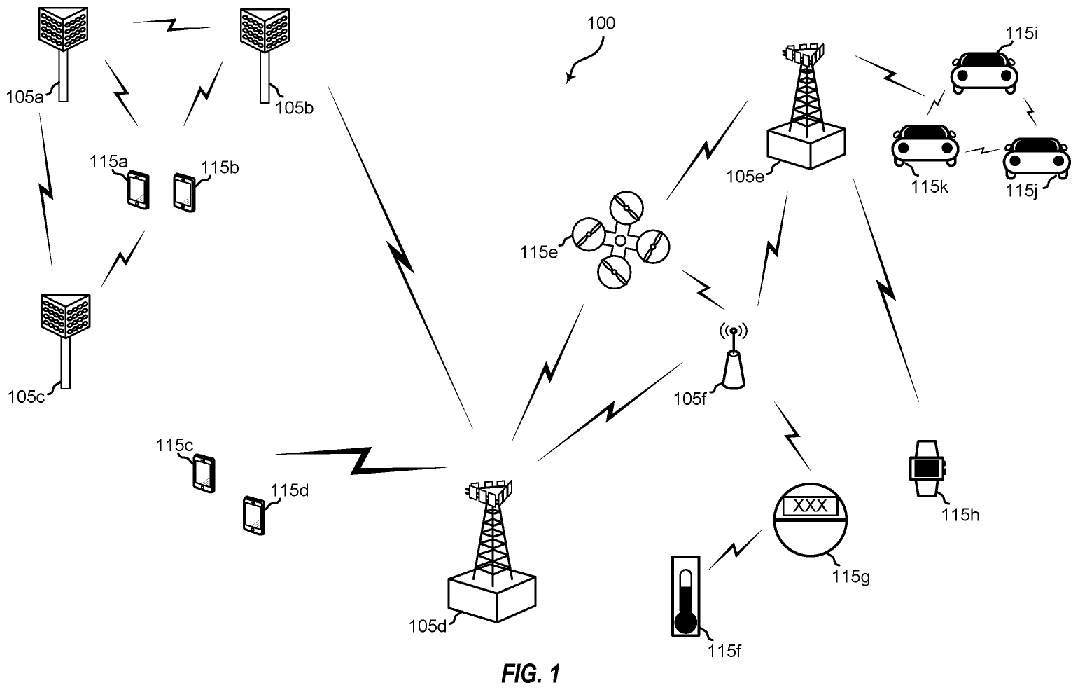

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115c, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

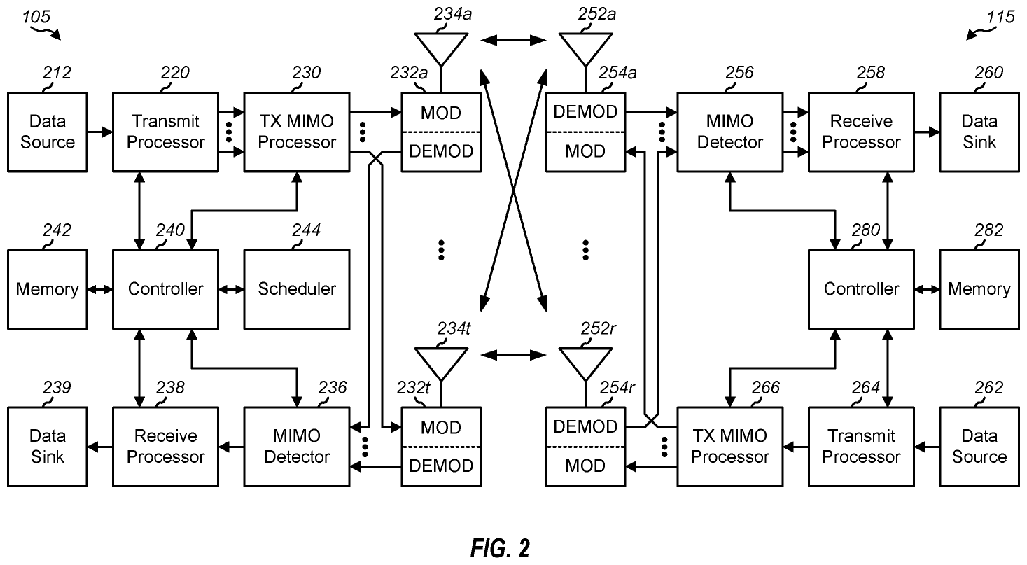

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

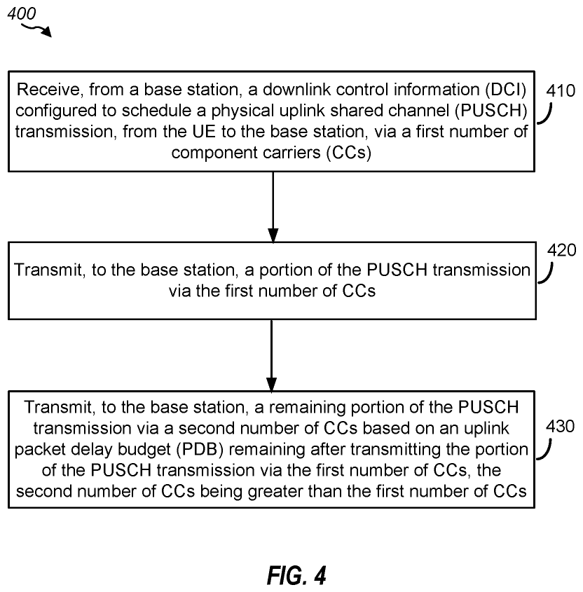

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 4, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

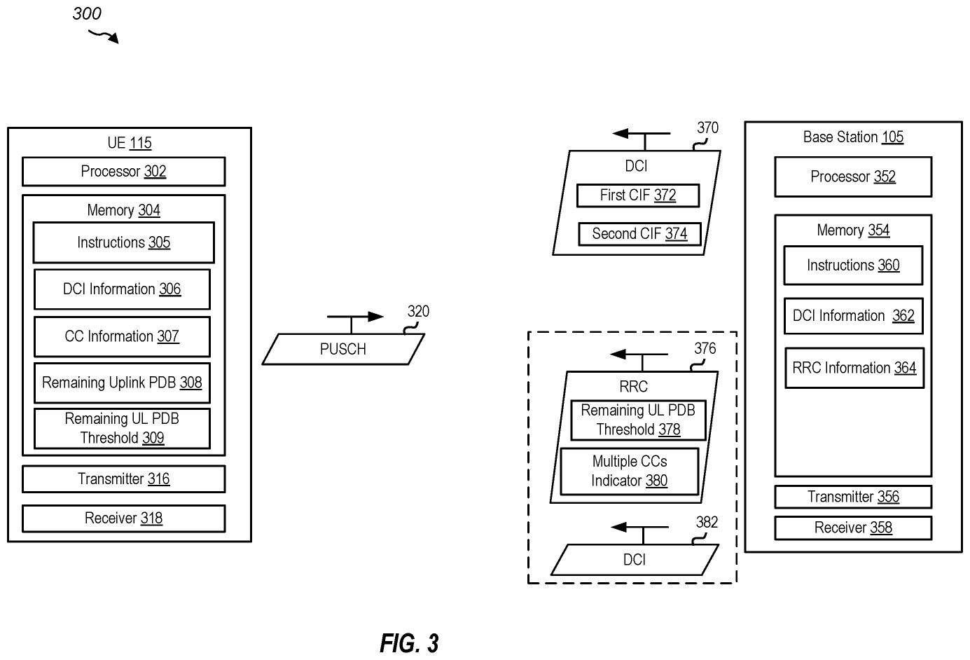

FIG. 3 is a block diagram of an example wireless communications system 300 that supports adaptive multi-component carrier scheduling for PUSCH transmissions, according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, multiple base stations 105, or a combination thereof.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store instructions 305, DCI information 306, component carrier (CC) information 307, remaining uplink (UL) PDB 308, or remaining UL PDB threshold 309. DCI information 306 may include or indicate information based on DCI received from the base station 105. For example, DCI information 306 may include or indicate information based on DCI 370 or DCI 382. CC information 307 may include or indicate information identifying the component carrier(s) that the UE 115 may utilize in transmitting PUSCH 320 based on remaining UL PDB 308 experienced by the UE 115 during the transmission of the PUSCH 320. The information may also include the identity, the number, etc., of the component carrier(s). The CC information 307 may be based on DCI 370 or RRC 376 (e.g., multiple CCs indicator 380). Remaining UL PDB 308 may be the latency experienced by the UE 115 in transmitting PUSCH 320 via a CC (e.g., a single CC). For example, the remaining UL PDB 308 can be the amount or portion of the UL PDB 308 that is remaining after the partial transmission of a portion of the PUSCH 320 via the single CC (e.g., after the transmission of the PUSCH 320 is commenced but before it is completed). The remaining UL PDB threshold 309 can be the threshold that the UE 115 may use to decide whether to switch to using multiple component carriers for transmitting the remaining portion of the PUSCH 320.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, UE 115 is a 5G-capable UE, a 6G-capable UE, or a combination thereof.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store instructions 360, DCI information 362, or RRC information 364. In some aspects, RRC information 364 may include information related to the RRC message 376 that the base station 105 may provide to the UE 115 to configure the UE 115. Examples of the RRC information 364 may include information related to RRC-configured values such as the UL latency threshold 378, identity and/or number of component carriers that the UE 115 may switch to using when transmitting PUSCH 320 (e.g., based on remaining UL PDB 308 experienced by the UE during the transmission of the PUSCH 320).

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, base station 105 may include one or more antenna arrays. The antenna array may include multiple antenna elements configured to perform wireless communications with other devices, such as with the UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, in some aspects, the UE 115 may explicitly or implicitly be adapted or configured to utilize multiple component carriers for transmitting PUSCH transmissions. With respect to the former, the UE may receive from the base station 105 a DCI 370 that is configured to schedule multiple component carriers for PUSCH transmissions. For example, the base station 105 may generate a single DCI 370 and transmit the same to the UE 115, with the single DCI 370 configured to schedule more than one component carriers that the UE 115 can choose from for transmitting one or more PUSCH transmissions. For instance, the DCI 370 may include more than one carrier indicator fields (CIFs) that are configured to indicate the afore-mentioned multiple component carriers. As a non-limiting illustrative example, the DCI 370 can have two CIFs, a first CIF 372 indicating a first number of component carriers and a second CIF indicating a second number of component carriers that is greater than the first number of component carriers. That is, the second CIF 374 may be configured to indicate more component carriers than the first CIF 372. In some examples, the first number of component carriers can be one component carrier while the second number of component carriers can be greater than one (e.g., two, three, etc.).

In some aspects, an indication of a given number of component carriers by a CIF may identify the carrier components (e.g., their identities, numbers, etc.) that include the scheduled resources which the UE may utilize for transmitting PUSCH transmissions to the base station. For example, when the first CIF 372 indicates one component carrier, the UE 115 may understand that it may utilize a resource in the component carrier identified by CIF 372 to transmit a PUSCH transmission (e.g., PUSCH 320) to the base station 105. That is, CIF 372 may identify to the UE the component carrier that includes the network resources (e.g., frequency domain and/or time domain resources) that the UE may use for the PUSCH transmission. As another example, when the second CIF 374 indicates two component carriers, the UE 115 may understand that it may utilize network resources located in both component carriers to transmit the PUSCH transmissions. That is, the second CIF 374 may indicate to the UE 115 the identity and/or number of component carriers (i.e., two component carriers) that includes the network resources that the UE can use for the PUSCH transmission. In some aspects, one or more of the CIFs in the DCI 370 (e.g., the first CIF, 372, the second CIF 374) may have 0-bit or 3-bit values, as defined in Section 10.1 of the 3GPP standard document technical specification “Physical layer procedures for control; 3GPP TS 38.213 (Release 16)”, which is incorporated herein by reference in its entirety.

After receiving DCI 370, in some aspects, the UE 115 may start transmitting PUSCH 320 using the component carrier indicated by the first CIF 372. That is, the UE 115 may start transmitting PUSCH 320 via a resource that is located at the component carrier indicated by first CIF 372 (if the first CIF 372 indicates more than one component carriers, the UE 115 may then transmit PUSCH 320 using resources located at those multiple component carriers). In some implementations, the transmission of the PUSCH 320 via the component carrier indicated by first CIF 372 may have associated therewith a remaining uplink (UL) PDB threshold 309. The remaining UL PDB threshold 309 may indicate to the UE 115 the latency condition that the transmission of the PUSCH 320 may have to fulfil so that the UE 115 may continue to use the component carrier indicated by the first CIF 372 or may switch to using the component carriers indicated by the second CIF 374, for transmitting the PUSCH 320 to the base station 105. In some aspects, the latency condition can be the amount of the UL PDB that is remaining (e.g., from the UL PDB allotted for the PUSCH 320 transmission over the component carrier indicated by the first CIF 372) after a portion of the PUSCH 320 is transmitted to the base station 105 via that component carrier.

For example, the remaining UL PDB threshold 309 may specify the maximum amount of time it may take for a given portion of the PUSCH 320 to be transmitted to the base station 105. In such cases, the UE 115 may track the remaining UL PDB 308 of the PUSCH transmission 320, and if the remaining UL PDB 308 indicates that at least the given portion of the PUSCH 320 is or is not transmitted within the maximum amount of time (i.e., the remaining UL PDB 308 satisfies or fails to satisfy the remaining UL PDB threshold 309), then the UE 115 may continue using the component carrier indicated by the first CIF 372 or switch to using the component carriers indicated by the second CIF 374, respectively, for transmitting the remaining PUSCH 320 to the base station 105.

As another example, the remaining UL PDB threshold 309 may specify the minimum portion of PUSCH 320 that should be transmitted to the base station 105 over a given time period. In such cases, if the remaining UL PDB 308 tracked by the UE 115 indicates that at least the minimum portion of PUSCH 320 is or is not transmitted within the given time period (i.e., the remaining UL PDB 308 satisfies or fails to satisfy the remaining UL PDB threshold 309), the UE 115 may continue using the component carrier indicated by the first CIF 372 or switch to using the component carriers indicated by the second CIF 374, respectively, for transmitting the remaining PUSCH 320 to the base station 105. It should be apparent from the above discussion that the remaining UL PDB thresholds identified above are non-limiting examples and that the remaining UL PDB threshold 309 can include any other formulation of a remaining UL PDB threshold that measures the progress of the transmission of the PUSCH 320 via the component carrier identified by first CIF 372. The UE 115 can then continue to use the component carrier of first CIF 372 or switch to using the component carriers of second CIF 374 based on whether the remaining UL PDB 308 of the transmission of the PUSCH 320 satisfies or fails to satisfy, respectively, the remaining UL PDB threshold 309.

In some aspects, as noted above, the UE 115 may implicitly be adapted or configured to utilize multiple component carriers for transmitting PUSCH transmissions. In such aspects, the UE 115 may receive from the base station 105 a RRC message 376 that the UE 115 may use to pre-configure the UE 115 for adaptive multi-component carrier scheduling for PUSCH transmissions. For example, the base station 105 may generate and transmit to the UE 115 a RRC message 376 that includes values related to the remaining UL PDB threshold 378, and/or the multiple component carriers (CCs) indicator 380 indicating the component carriers that the UE 115 may switch to using when the remaining UL PDB of the transmission of PUSCH 320 fails to satisfy the remaining UL PDB threshold 378. The UE 115 may then use the RRC configured values (e.g., the remaining UL PDB threshold 378 and/or the multiple CCs indicator 380) to configure the UE 115. For instance, the remaining UL PDB threshold 309 may correspond to the remaining UL PDB threshold 378 from the RRC 376. As another example, the CC information 307 may include or correspond to information (e.g., identify, number, etc.) of the multiple of CCs indicator 380.

In some aspects, the UE 115 may receive a DCI 382 from the base station 105. The DCI 382 may be configured to schedule the transmission of the PUSCH 320 from the UE 115 to the base station 105 and may include a CIF indicating a component carrier that the UE 115 may use for the PUSCH transmission. The UE 115 may then start transmitting the PUSCH 320 using the component carrier (e.g., a resource located in that component carrier) identified by the DCI 382. In some aspects, the UE 115 may track the remaining UL PDB 308 of the transmission of the PUSCH 320 and compare the remaining UL PDB 308 with the RRC-configured remaining UL PDB threshold 309 (e.g., which corresponds to the remaining UL PDB threshold 378 from the RRC 376). If the remaining UL PDB 308 satisfies the remaining UL PDB threshold 309/378, the UE 115 may continue to transmit the PUSCH 320 using the component carrier identified in the DCI 382. If, on the other hand, the remaining UL PDB 308 fails to satisfy the remaining UL PDB threshold 309/378, the UE 115 may switch to using the multiple component carriers indicated by the multiple CCs indicator 380 for transmitting the remaining portion of the PUSCH 320 to the base station 105 (e.g., the portion that is remaining after the partial transmission of the PUSCH via the component carrier identified in the DCI 382). That is, the UE 115 may use resources at the multiple component carriers to transmit the PUSCH 320 to the base station 105. The number of the multiple component carriers indicated by the multiple CCs indicator 380 (e.g., two, three, etc.) may be greater than the number of the component carrier (e.g., one) indicated by the DCI 382.

In the discussion above related to the explicit adaptation or configuration of the UE 115 to utilize multiple component carriers for transmitting a PUSCH transmission 320, the UE 115 switches from using the component carrier indicated or identified by the first CIF 372 to using the component carriers indicated or identified by the second CIF 374. The number of component carriers indicated or identified by the second CIF 374 may be greater than the number of component carrier(s) indicated or identified by the first CIF 372. That is, after initiating the transmission of the PUSCH 320 using the component carrier(s) indicated by the first CIF 372, the UE 115 may transmit the remaining PUSCH 320 via the component carriers indicated by the second CIF 374 when the remaining UL PDB 308 fails to satisfy the remaining UL PDB threshold 309. In some aspects, instead of switching to the component carriers indicated by the second CIF 374, the UE 115 may transmit the remaining portion of the PUSCH 320 using both components carrier(s) identified by first CIF 372 and components carriers identified by second CIF 374. In such cases, the number of component carriers of first CIF 372 may not necessarily be less than the number of component carriers of second CIF 374, but rather may be less than, equal to, or greater than the number of component carriers of second CIF 374. In such cases, the UE 115 may then transmit the remaining portion of the PUSCH 320 via more number of component carriers than the number of component carriers indicated by first CIF 372 (e.g., using the components carriers identified by both the first CIF 372 and the second CIF 374). For instance, both the number of component carriers indicated by first CIF 372 and the number of component carriers indicated by second CIF 374 can be equal to one. The UE 115 may then transmit PUSCH 320 via one component carrier (i.e., via the component carrier indicated by the first CIF 372) as long as the remaining UL PDB 308 satisfies the remaining UL PDB threshold 309, and then, when the remaining UL PDB 308 fails to satisfy the remaining UL PDB threshold 309, transmit the remaining PUSCH 320 via two component carriers (e.g., via both the component carrier indicated by the first CIF 372 and the component carrier indicated by the second CIF 374).

In the discussion above related to the implicit adaptation or configuration of the UE 115 to utilize multiple component carriers for transmitting a PUSCH transmission 320, the UE 115 switches from using the component carrier indicated or identified by the DCI 382 to using the component carriers indicated or identified by the multiple CCs indicator 380.

The number of component carriers indicated by the multiple CCs indicator 380 may be greater than the number of component carrier(s) indicated or identified by the DCI 382. That is, after initiating the transmission of the PUSCH 320 using the component carrier(s) indicated by the DCI 382 (e.g., after transmitting a portion of PUSCH 320 via the component carrier(s) indicated by the DCI 382), the UE 115 may transmit the remaining portion of the PUSCH 320 via the component carriers indicated by the multiple CCs indicator 380 when the remaining UL PDB 308 fails to satisfy the remaining UL PDB threshold 378. In some aspects, instead of switching to the component carriers indicated by the multiple CCs indicator 380, the UE 115 may transmit the remaining portion of the PUSCH 320 using both components carrier(s) identified by DCI 382 and components carriers identified by the multiple CCs indicator 380. In such cases, the number of component carriers indicated by DCI 382 may not necessarily be less than the number of component carriers indicated by the multiple CCs indicator 380, but rather may be less than, equal to, or greater than the number of component carriers indicated by the multiple CCs indicator 380. In such cases, the UE 115 may then transmit the remaining PUSCH 320 via more number of component carriers than the number of component carriers indicated by the DCI 382 (e.g., using the components carriers identified by both the DCI 382 and the multiple CCs indicator 380). For instance, if the number of component carriers indicated by the DCI 382 is one and the number of component carriers indicated by the multiple CCs indicator 380 is two, then the UE 115 may transmit PUSCH 320 via one component carrier (i.e., the component carrier indicated by DCI 382) as long as the remaining UL PDB 308 satisfies the remaining UL PDB threshold 378, and then transmit the remaining PUSCH 320 via three component carriers (e.g., via both the one component carrier indicated by DCI 382 and the two component carriers indicated by the multiple CCs indicator 380) when the remaining UL PDB 308 fails to satisfy the remaining UL PDB threshold 378.

As described with reference to FIG. 3, the present disclosure provides techniques for mitigating or avoiding inefficient use of network resources, disruption to network operations, degraded user experiences, etc., that may result when an uplink transmission is delayed, and in some cases, dropped. In the explicit or implicit adaptation or configuration of the UE 115 to utilize multiple component carriers for transmitting a PUSCH transmission 320, in some aspects, the UE 115 is configured to use additional component carriers for transmitting the PUSCH 320 to the base station 105 when a comparison of the remaining UL PDB 308 and the remaining UL PDB threshold 309/378 indicates that the full transmission of the PUSCH 320 via a first set of component carriers (e.g., one component carrier) may not be completed successfully. The first set of component carriers may be indicated by the DCI 370 (e.g., by first CIF 372) or DCI 382. For example, the comparison may indicate that a minimum amount of PUSCH 320 has not been transmitted within a prescribed time duration, indicating that PUSCH 320 may not be fully transmitted via the scheduled resources of the first set of component carriers. In such cases, the UE 115 may be capable of utilizing additional component carriers for transmitting the PUSCH 320, facilitating the full transmission of PUSCH 320 to the base station 105. For example, the UE 115 may utilize the component carriers identified by second CIF 374 and/or by multiple CCs indicator 380. The UE 115 can switch to using these additional component carriers (e.g., where the number of component carriers indicated by second CIF 374 or multiple CCs indicator 380 is greater than that indicated by first CIF 372 or DCI 382, respectively) or can use these component carriers in addition to the first set of component carriers. In either case, the UE 115 can avail itself to additional resources from the component carriers indicated by second CIF 374 or multiple CCs indicator 380 for transmission of PUSCH 320, thereby facilitating the complete transmission of PUSCH 320 to the base station 105.

In some aspects, instead of or in addition to using a L1 message such as DCI to indicate the remaining uplink PDB and/or the remaining uplink PDB threshold, the base station may use a higher layer signaling (e.g., L2/L3 signaling) to provide or indicate to the UE the remaining uplink PDB and/or the remaining uplink PDB threshold. For example, the base station may utilize a layer 2 (L2) message and/or a layer 3 (L3) message such as but not limited to an RRC message, a MAC-CE message, etc., to indicate the remaining uplink PDB and/or the remaining uplink PDB threshold to the UE.

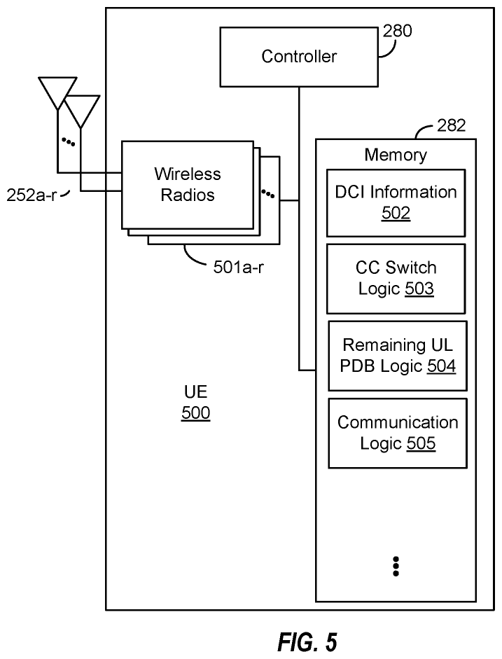

FIG. 4 is a flow diagram illustrating an example process 400 that supports adaptive multi-component carrier scheduling for PUSCH transmissions according to one or more aspects. Operations of process 400 may be performed by a UE, such as UE 115 described above with reference to FIGS. 1, 2, 3, or a UE 500 described with reference to FIG. 5. For example, example operations (also referred to as “blocks”) of process 400 may enable UE 115 to support adaptive multi-component carrier scheduling for PUSCH transmissions.

In block 410, the UE may receive, from a base station, a DCI configured to schedule a PUSCH transmission from the UE to the base station using a first number of component carriers. In some aspects, the DCI can be DCI 370 received from the base station 105, and the first number of component carriers may be indicated by the first CIF 372 of the DCI 370. In some aspects, the DCI can be DCI 382, and the first number of components may be indicated by the a CIF in the DCI 382.

In block 420, the UE may transmit, to the base station, a portion of the PUSCH transmission via the first number of component carriers. In some aspects, the PUSCH can be PUSCH 320.

In block 430, the UE may transmit to the base station a remaining portion of the PUSCH transmission via a second number of component carriers based on an uplink packet delay budget (PDB) remaining after transmitting the portion of the PUSCH transmission using the first number of component carriers. In some aspects, the second number of component carriers may be the number of component carriers indicated by the second CIF 374 of the DCI 370 received by the UE 115. In some implementations, the second number of component carriers may be indicated by a RRC configured value. For example, the second number of component carriers may be indicated by the number of the multiple CCs 380 included in the RRC configuration 376 transmitted by the base station 105 and received by the UE 115. In some aspects, the second number of component carriers can be greater than the first number of component carriers. That is, for example, the second number of component carriers indicated by the second CIF can be greater than the first number of component carriers indicated by the first CIF. As another example, the second number of the multiple CCs 380 indicated in the RRC configuration 376 may be greater than the first number of component carriers indicated by the DCI 382. For instance, the first number of component carriers can be one and the second number of component carriers can be two or more.

In some implementations, the DCI is further configured to schedule the transmission of the PUSCH by the UE to the base station via the second number of component carriers. For example, the DCI can be DCI 370 that includes a second CIF 374 that indicates the components carriers that the UE 115 may switch to using to transmit to the base station 105 the remaining portion of the PUSCH 320 after the partial transmission of the PUSCH 320 via the first number of component carriers. That is, in some aspects, the DCI may include a first CIF 372 identifying a first number of component carriers to transmit PUSCH 320 to the base station 105. Further, the same DCI 370 may also include the second CIF 374 that indicates the second component carriers that the UE 115 can switch to (e.g., from using the component carrier(s) identified by the first CIF 372) to transmit PUSCH 320 to the base station 105.

In some implementations, the DCI includes an indication of a remaining uplink PDB threshold, and the UE may switch to using the second number of component carriers based on a comparison of the remaining uplink PDB and the remaining uplink PDB threshold. For example, the UE may transmit the remaining PUSCH transmission using the second number of component carriers when the remaining uplink PDB fails to satisfy the remaining uplink PDB threshold. When the remaining uplink PDB satisfies the remaining uplink PDB threshold, the UE may transmit the PUSCH transmission using the first number of component carriers.

In some implementations, the UE may switch to transmitting the PUSCH via the second number of components based on a RRC configured value which may indicate the second number of component carriers and/or the remaining uplink PDB threshold. The RRC configured value may be received at the UE via a RRC message transmitted from the base station. For example, the RRC message can be RRC 376, and the RRC configured value may indicate the remaining uplink PDB threshold 378 and/or the multiple CCs 380, the latter of which the UE 115 may switch to using when transmitting the remaining portion of the PUSCH 320 to the base station 105. As noted above, the switching may be based on the remaining uplink PDB threshold 378.

FIG. 5 is a block diagram of an example UE 500 that supports adaptive multi-component carrier scheduling for PUSCH transmissions according to one or more aspects. UE 500 may be configured to perform operations, including the blocks of a process described with reference to FIG. 4. In some implementations, UE 500 includes the structure, hardware, and components shown and described with reference to UE 115 of FIGS. 1-3. For example, UE 500 includes controller 280, which operates to execute logic or computer instructions stored in memory 282, as well as controlling the components of UE 500 that provide the features and functionality of UE 500. UE 500, under control of controller 280, transmits and receives signals via wireless radios 501a-r and antennas 252a-r. Wireless radios 501a-r include various components and hardware, as illustrated in FIG. 2 for UE 115, including modulator and demodulators 254a-r, MIMO detector 256, receive processor 258, transmit processor 264, and TX MIMO processor 266.

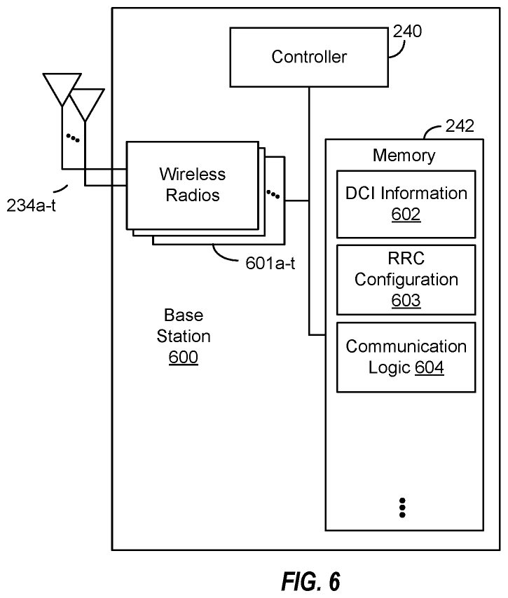

As shown, memory 282 may include DCI information 502, CC switch logic 503, remaining uplink PDB logic 504, and communication logic 505. DCI information 502 may correspond to DCI information 306. CC switch logic 503 may be configured to switch transmission of PUSCH based on CC information 307. Remaining uplink PDB logic 504 may be configured to determine remaining uplink PDB 308 or may be configured to store a remaining uplink PDB threshold 309. Communication logic 505 may be configured to enable communication between UE 500 and one or more other devices. UE 500 may receive signals from or transmit signals to one or more network entities, such as base station 105 of FIGS. 1-3 or a base station as illustrated in FIG. 6.

FIG. 6 is a block diagram of an example base station 600 that supports adaptive multi-component carrier scheduling for PUSCH transmissions according to one or more aspects. Base station 600 may be configured to perform operations, including the blocks of process 400 described with reference to FIG. 4. In some implementations, base station 600 includes the structure, hardware, and components shown and described with reference to base station 105 of FIGS. 1-3. For example, base station 600 may include controller 240, which operates to execute logic or computer instructions stored in memory 242, as well as controlling the components of base station 600 that provide the features and functionality of base station 600. Base station 600, under control of controller 240, transmits and receives signals via wireless radios 201a-t and antennas 234a-t. Wireless radios 601a-t include various components and hardware, as illustrated in FIG. 2 for base station 105, including modulator and demodulators 232a-t, transmit processor 220, TX MIMO processor 230, MIMO detector 236, and receive processor 238.

As shown, memory 242 may include DCI information 602, RRC configuration 603, and communication logic 604. DCI information 602 correspond to DCI information 362. RRC configuration 603 may include RRC information 364. Communication logic 605 may be configured to enable communication between base station 600 and one or more other devices. Base station 600 may receive signals from or transmit signals to one or more UEs, such as UE 115 of FIGS. 1-3 or UE 500 of FIG. 5.

In one or more aspects, techniques for supporting adaptive multi-component carrier scheduling for PUSCH transmissions may include additional aspects, such as any single aspect or any combination of aspects described below or in connection with one or more other processes or devices described elsewhere herein. In a first aspect, techniques for supporting adaptive multi-component carrier scheduling for PUSCH transmissions may include a UE receiving, from a base station, a DCI configured to schedule a PUSCH transmission to the base station using a first number of component carriers. The UE may then transmit, to the base station, the PUSCH transmission using a second number of component carriers based on an uplink packet delay budget (PDB) remaining after transmitting the PUSCH transmission using the first number of CCs. The second number of component carriers can be greater than the first number of component carriers. In some examples, the techniques of the first aspect may be implemented in a wireless communication device, which may include a UE or a component of a UE. For example, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the DCI is further configured to schedule the PUSCH transmission to the base station using the second number of CCs.

In a third aspect, in combination with one or more of the first aspect or the second aspect, the DCI includes a first carrier indicator field (CIF) and a second CIF, the first CIF configured to identify the first number of CCs and the second CIF configured to identify the second number of CCs.

In a fourth aspect, in combination with one or more of the first aspect through the third aspect, the DCI includes an indication of a remaining uplink PDB threshold and the transmitting the PUSCH transmission using the second number of CCs includes transmitting the PUSCH transmission using the second number of CCs when the remaining uplink PDB fails to satisfy the remaining uplink PDB threshold.

In a fifth aspect, in combination with one or more of the first aspect through the fourth aspect, the techniques further comprise transmitting, to the base station, the PUSCH transmission using the first number of CCs when the remaining uplink PDB satisfies the remaining uplink PDB threshold.

In a sixth aspect, in combination with one or more of the first aspect through the fifth aspect, the first number of CCs equals one and the second number of CCs equals two or more.

In a seventh aspect, in combination with one or more of the first aspect through the sixth aspect, the techniques further comprise transmitting the PUSCH transmission using the second number of CCs based on a radio resource control (RRC) configured value.

In an eighth aspect, in combination with one or more of the first aspect through the seventh aspect, the RRC configured value indicates the second number of CCs.

In a ninth aspect, in combination with one or more of the first aspect through the eighth aspect, the RRC configured value indicates an remaining uplink PDB threshold; and the techniques further comprise the transmitting the PUSCH transmission using the second number of CCs based on the RRC configured value includes transmitting the PUSCH transmission using the second number of CCs when the remaining uplink PDB fails to satisfy the remaining uplink PDB threshold.

In a tenth aspect, in combination with one or more of the first aspect through the ninth aspect, the techniques further comprise receiving, from the base station, a RRC configuration including the RRC configured value.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A user equipment (UE) comprising:
a memory storing processor-readable code; and
at least one processor coupled to the memory, the at least one processor configured to execute the processor-readable code to cause the at least one processor to:
receive, from a base station, a downlink control information (DCI) configured to schedule a physical uplink shared channel (PUSCH) transmission, from the UE to the base station, via a first number of component carriers (CCs);
transmit, to the base station, a portion of the PUSCH transmission via the first number of CCs; and
transmit, to the base station, a remaining portion of the PUSCH transmission via a second number of CCs based on an uplink packet delay budget (PDB) remaining after transmitting the portion of the PUSCH transmission via the first number of CCs, the second number of CCs being greater than the first number of CCs.

2. The UE of claim 1, wherein the DCI is further configured to schedule the PUSCH transmission, from the UE to the base station, via the second number of CCs.

3. The UE of claim 1, wherein the DCI includes a first carrier indicator field (CIF) and a second CIF, the first CIF identifies the first number of CCs and the second CIF identifies the second number of CCs.

4. The UE of claim 1, wherein the DCI includes an indication of a remaining uplink PDB threshold and the at least one processor transmits the remaining portion of the PUSCH transmission via the second number of CCs when the remaining uplink PDB fails to satisfy the remaining uplink PDB threshold.

5. The UE of claim 4, wherein the at least one processor is further configured to transmit, to the base station, the remaining portion of the PUSCH transmission via the first number of CCs when the remaining uplink PDB satisfies the remaining uplink PDB threshold.

6. The UE of claim 1, wherein the first number of CCs equals one and the second number of CCs equals two or more.

7. The UE of claim 1, wherein the at least one processor transmits the remaining portion of the PUSCH transmission via the second number of CCs based on a radio resource control (RRC) configured value.

8. The UE of claim 7, wherein the RRC configured value indicates the second number of CCs.

9. The UE of claim 7, wherein:
the RRC configured value indicates a remaining uplink PDB threshold; and
the at least one processor transmits the remaining portion of the PUSCH transmission via the second number of CCs based on the RRC configured value when the remaining uplink PDB fails to satisfy the remaining uplink PDB threshold.

10. The UE of claim 9, wherein the at least one processor is configured to transmit, to the base station, the remaining portion of the PUSCH transmission via the first number of CCs when the remaining uplink PDB satisfies the remaining uplink PDB threshold.

11. A method for wireless communication performed by a user equipment (UE), comprising:
receiving, from a base station, a downlink control information (DCI) configured to schedule a physical uplink shared channel (PUSCH) transmission, from the UE to the base station, via a first number of component carriers (CCs);
transmitting, to the base station, a portion of the PUSCH transmission via the first number of CCs; and
transmitting, to the base station, a remaining portion of the PUSCH transmission via a second number of CCs based on an uplink packet delay budget (PDB) remaining after transmitting the portion of the PUSCH transmission via the first number of CCs, the second number of CCs being greater than the first number of CCs.

12. The method of claim 11, wherein the DCI is further configured to schedule the PUSCH transmission, from the UE to the base station, via the second number of CCs.

13. The method of claim 11, wherein the DCI includes a first carrier indicator field (CIF) and a second CIF, the first CIF identifies the first number of CCs and the second CIF identifies the second number of CCs.

14. The method of claim 11, wherein the DCI includes an indication of a remaining uplink PDB threshold and the transmitting the remaining portion of the PUSCH transmission via the second number of CCs includes transmitting the remaining portion of the PUSCH transmission via the second number of CCs when the remaining uplink PDB fails to satisfy the remaining uplink PDB threshold.

15. The method of claim 14, further comprising transmitting, to the base station, the remaining portion of the PUSCH transmission using the first number of CCs when the remaining uplink PDB satisfies the remaining uplink PDB threshold.

16. The method of claim 11, wherein the first number of CCs equals one and the second number of CCs equals two or more.

17. The method of claim 11, wherein the transmitting the remaining portion of the PUSCH transmission via the second number of CCs includes transmitting the PUSCH transmission via the second number of CCs based on a radio resource control (RRC) configured value.

18. The method of claim 17, wherein the RRC configured value indicates the second number of CCs.

19. The method of claim 17, wherein:
the RRC configured value indicates a remaining uplink PDB threshold; and
the transmitting the remaining portion of the PUSCH transmission via the second number of CCs based on the RRC configured value includes transmitting the remaining portion of the PUSCH transmission via the second number of CCs when the remaining uplink PDB fails to satisfy the remaining uplink PDB threshold.

20. The method of claim 17, further comprising receiving, from the base station, a RRC message including the RRC configured value.

21. An apparatus configured for wireless communication, the apparatus comprising:
means for receiving, from a base station, a downlink control information (DCI) configured to schedule a physical uplink shared channel (PUSCH) transmission, from the apparatus to the base station, via a first number of component carriers (CCs);
means for transmitting, to the base station, a portion of the PUSCH transmission via the first number of CCs; and
means for transmitting, to the base station, a remaining portion of the PUSCH transmission via a second number of CCs based on an uplink packet delay budget (PDB) remaining after transmitting the portion of the PUSCH transmission via the first number of CCs, the second number of CCs being greater than the first number of CCs.

22. The apparatus of claim 21, wherein the DCI includes a first carrier indicator field (CIF) and a second CIF, the first CIF identifies the first number of CCs and the second CIF identifies the second number of CCs.

23. The apparatus of claim 21, wherein the DCI includes an indication of a remaining uplink PDB threshold and the means for transmitting includes the means for transmitting the PUSCH transmission using the second number of CCs when the remaining uplink PDB fails to satisfy the remaining uplink PDB threshold.

24. The apparatus of claim 21, wherein the means for transmitting the remaining portion of the PUSCH transmission via the second number of CCs includes the means for transmitting the remaining portion of the PUSCH transmission via the second number of CCs based on a radio resource control (RRC) configured value.

25. The apparatus of claim 24, wherein:
the RRC configured value indicates the second number of CCs and a remaining uplink PDB threshold; and
the means for transmitting the remaining portion of the PUSCH transmission via the second number of CCs based on the RRC configured value includes the means for transmitting the PUSCH transmission using the second number of CCs based on the RRC configured value when the remaining uplink PDB fails to satisfy the remaining uplink PDB threshold.

26. A non-transitory computer-readable medium storing instructions that, when executed by a processor, cause the processor to perform operations comprising:
receiving, from a base station, a downlink control information (DCI) configured to schedule a physical uplink shared channel (PUSCH) transmission, from a user equipment (UE) to the base station, via a first number of component carriers (CCs);
transmitting, to the base station, a portion of the PUSCH transmission via the first number of CCs; and
transmitting, to the base station, a remaining portion of the PUSCH transmission using a second number of CCs based on an uplink packet delay budget (PDB) remaining after transmitting the portion of the PUSCH transmission using the first number of CCs, the second number of CCs being greater than the first number of CCs.

27. The non-transitory computer-readable medium of claim 26, wherein the DCI is further configured to schedule the PUSCH transmission, from the UE to the base station, via the second number of CCs.

28. The non-transitory computer-readable medium of claim 26, wherein the DCI includes an indication of a remaining uplink PDB threshold and the operations further comprise transmitting, to the base station, the remaining portion of the PUSCH transmission using the first number of CCs when the remaining uplink PDB satisfies the remaining uplink PDB threshold.

29. The non-transitory computer-readable medium of claim 26, wherein the operations further comprise receiving, from the base station, a RRC message including an RRC configured value indicating the second number of CCs and a remaining uplink PDB threshold.

30. The non-transitory computer-readable medium of claim 29, wherein the processor transmits, to the base station, the remaining portion of the PUSCH transmission using the second number of CCs when the remaining uplink PDB fails to satisfy the remaining uplink PDB threshold.
